(19) United States
(12) Patent Application Publication
(10) Pub. No.: US 2024/0234859 A1
(43) Pub. Date: Jul. 11, 2024

(54) HOLLOW COPPER THERMAL CONDUCTORS

(71) Applicant: GM Global Technology Operations LLC, Detroit, MI (US)

(72) Inventors: Andrew Clay BOBEL, Troy, MI (US); Anil K. Sachdev, Rochester Hills, MI (US); Anthony Michael Coppola, Rochester Hills, MI (US); Sayed Youssef Sayed Nagy, Troy, MI (US); Jian Yao, Shanghai (CN)

(21) Appl. No.: 18/356,765

(22) Filed: Jul. 21, 2023

(30) Foreign Application Priority Data
Jan. 6, 2023 (CN) 202310023538.3

(51) Int. Cl. H01M 10/653; C25D 3/38; C25D 5/50; C25D 7/06; H01M 10/613; H01M 10/6557; H01M 10/6567; H01M 50/213

(52) U.S. Cl. CPC H01M 10/653; C25D 3/38; C25D 5/50; C25D 7/0671; H01M 10/613; H01M 10/6557; H01M 10/6567; H01M 50/213

(57) ABSTRACT

A process for making a ribbon-shaped hollow thermal conductor includes forming a sacrificial material into an insert including a plurality of parallel strands. Plating the sacrificial insert with copper to form a ribbon-shaped structure and removing the sacrificial material from within the ribbon-shaped structure to create a hollow passage through a ribbon-shaped hollow copper thermal conductor.

### CROSS-REFERENCE TO RELATED APPLICATIONS

This application claims the benefit of Chinese Patent Application No. 202310023538.3, filed on Jan. 6, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a design for and a process of making hollow copper thermal conductors that can be formed as a thin ribbon for cooling between battery cells of a battery pack and in other applications.

### SUMMARY

A process for making a ribbon shaped, hollow thermal conductor, includes forming a sacrificial material into an insert including a plurality of parallel strands. Plating the sacrificial insert with copper to form a ribbon-shaped structure and removing the sacrificial material from within the ribbon-shaped structure to create a hollow passage through a ribbon-shaped, hollow copper thermal conductor.

According to a further aspect of the present disclosure, the sacrificial material includes a metal including one of tin, indium, zinc, aluminum, and magnesium.

According to a further aspect of the present disclosure, the sacrificial material includes a conductive polymer including one of polyamides, epoxies, polyesters, polyethylenes, acrylics, polyphenylene sulfides, polycarbonate, and acrylonitrile butadiene styrene.

According to a further aspect of the present disclosure, the sacrificial material includes a conductive hard wax including one of paraffin wax, montan wax, and polyethylene wax.

According to a further aspect of the present disclosure, the conductive hard wax further includes a filler.

According to a further aspect of the present disclosure, the sacrificial material includes a polymer including one of polyethylene glycol, polyacrylamides, polyacrylic acid copolymer, and polyvinyl alcohol.

According to a further aspect of the present disclosure, the sacrificial insert is formed by one of casting and extruding a metal into a coil shape.

According to a further aspect of the present disclosure, the sacrificial insert is formed by one of extruding and electropolymerizing a polymer in a template.

According to a further aspect of the present disclosure, the sacrificial insert is formed by molding a polymer.

According to a further aspect of the present disclosure, the sacrificial insert is formed by 3D printing.

According to a further aspect of the present disclosure, removing the sacrificial material from the within the copper plated coil shaped member includes one of melting, burning, and dissolving the sacrificial material.

According to another aspect of the present disclosure, a battery pack includes a housing having a plurality of battery cells in the housing. A ribbon-shaped hollow copper conductor is disposed between at least one adjacent group of the plurality of battery cells and a coolant source is connected to the ribbon-shaped hollow copper conductor.

According to a further aspect of the present disclosure, the ribbon-shaped hollow copper conductor includes a plurality of spaced passages therethrough.

According to a further aspect of the present disclosure, the coolant source includes a liquid coolant that is pumped through the ribbon-shaped hollow copper conductor.

According to a further aspect of the present disclosure, the ribbon-shaped hollow copper conductor has a height of between 50-100 percent of a height of the battery cells.

According to a further aspect of the present disclosure, the ribbon-shaped hollow copper conductor has a thickness of between 3 and 10 mm.

According to a further aspect of the present disclosure, a vehicle, includes a vehicle structure and a battery pack including, a housing mounted to the vehicle structure, a plurality of battery cells in the housing, a ribbon-shaped hollow copper conductor disposed between at least one adjacent group of the plurality of battery cells, and a coolant source connected to the ribbon-shaped hollow copper conductor.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a top plan view of the battery pack having hollow copper thermal conducting ribbons between the battery cells;

FIG. 2 is a top perspective view of the battery pack having hollow copper thermal conducting ribbons between the battery cells;

FIG. 3 is a partial cross-sectional view of the battery pack having hollow copper thermal conducting ribbons between the battery cells;

FIG. 4 is a cross-sectional view of an example hollow copper thermal conducting ribbon according to the principles of the present disclosure;

FIG. 5 is a schematic illustration for a method of making the ribbon-shaped hollow copper thermal conductor;

FIG. 6 is a schematic illustration of a vehicle battery pack having a coolant source according to the principles of the present disclosure; and

FIG. 7 is a schematic illustration showing a serpentine pattern of the hollow copper thermal conducting ribbons.

In the drawings, reference numbers may be reused to identify similar and/or identical elements.

### DETAILED DESCRIPTION

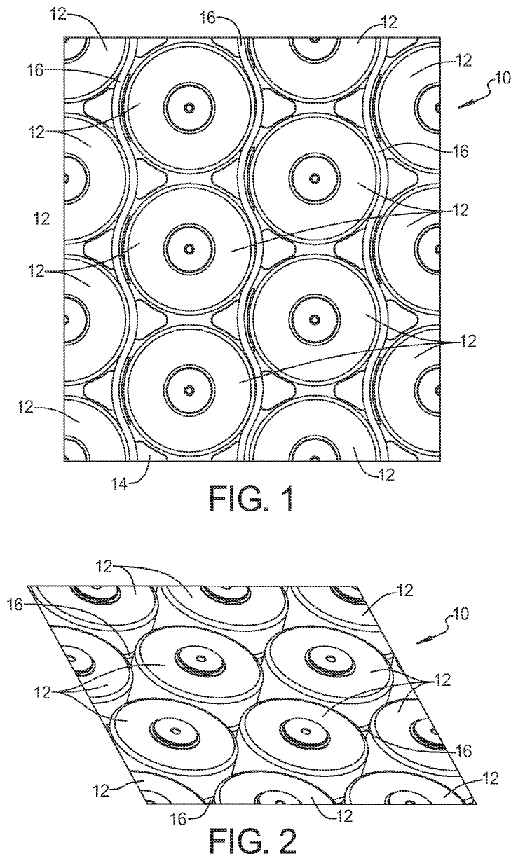

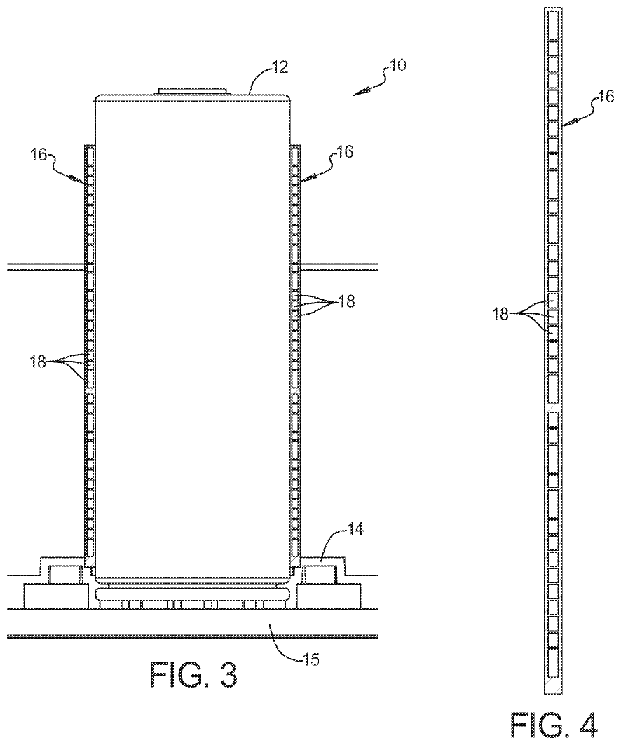

With reference to FIGS. 1-3 and 6, a battery pack 10 is shown including a plurality of battery cells 12 arranged closely packed within a battery housing structure 14. The battery pack 10 can be disposed within a vehicle 15, tool or other battery powered implement. As shown in FIGS. 1-3, a ribbon-shaped, hollow thermal conductor 16 is shown making several passes between adjacent groups of the battery cells 12. The groups of battery cells 12 can include rows or other arrangements. As best shown in FIGS. 3 and 4, the ribbon shaped, hollow thermal conductor 16 includes one or more hollow coolant passage(s) 18 therein that can be connected to a coolant source 20 via a manifold system that connects to one or both ends of the ribbon-shaped, hollow thermal conductors.

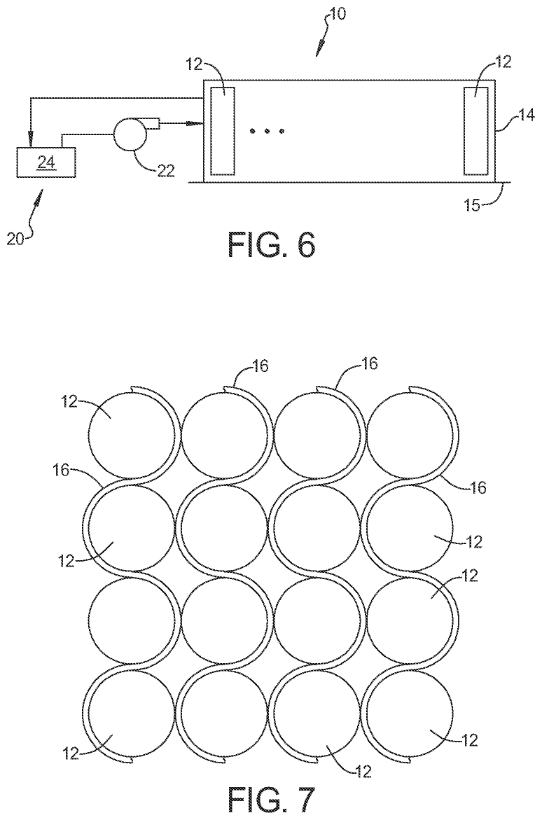

As shown in FIG. 6, the coolant source 20 can include a pump or fan 22 that is connected to a coolant reservoir 24. The coolant can be a liquid coolant or a gas such as air that can be forced through the hollow coolant passages 18 for actively cooling the battery cells 12. Because of its compliant nature, the ribbon-shaped, hollow copper thermal conductors 16 can pass in a serpentine manner between each battery cell 12 of a row as shown in FIG. 7.

The ribbon-shaped, hollow thermal conductor 16 can preferably have a height of between 50 percent to 100 percent and more preferably between 70-90 percent of a height of the battery cells 12. A thickness of the ribbon-shaped hollow thermal conductor 16 can preferably be between 1 and 3 mm with a wall thickness around the passages of between 0.1 and 0.5 mm.

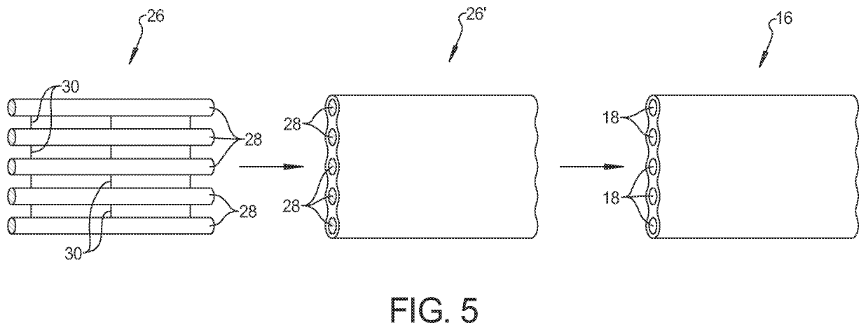

A process for making a ribbon shaped, hollow thermal conductor 16 according to the principles of the present disclosure will now be described. As shown in FIG. 5, a sacrificial insert 26 is formed as a plurality of parallel strands 28. A material of the sacrificial insert 26 can include a metal including one of tin, indium, zinc, aluminum, and magnesium. Accordingly, the sacrificial insert 26 can be formed by one of casting and extruding a metal into individual strands 28 that can be combined into a parallel arrangement of multiple strands 28 or can be extruded or cast into parallel strands 28. Tabs 30 can be used to secure the strands together at spaced locations. The number and shape of the individual strands 28 can vary depending upon the specific application. In the embodiment shown in FIG. 4, twenty (20) rectangular cross-section strands would have been utilized to form the twenty (20) passages 18 shown. In the embodiment shown in FIG. 5, only 5 circular cross-section strands are used.

Alternatively, the sacrificial material of the sacrificial insert 26 can include a conductive polymer including one of polyamides, epoxies, polyesters, polyethylenes, acrylics, polyphenylene sulfides, polycarbonate, and acrylonitrile butadiene styrene. Further, the sacrificial material of the sacrificial insert 26 can include a conductive hard wax including one of paraffin wax, montan wax, and polyethylene. The sacrificial material of the sacrificial insert 26 can also include a polymer including one of polyethylene glycol, polyacrylamides, polyacrylic acid copolymer, and polyvinyl alcohol. The sacrificial insert 26 can be formed by one of extruding and electropolymerizing a polymer in a template. Alternatively, the sacrificial insert 26 can be formed by molding the polymer. Finally, the sacrificial insert 26 can be formed by 3-D printing from various sacrificial materials.

The sacrificial insert 26 can be placed into a copper plating bath wherein the sacrificial insert is copper plated. Copper plating is a known electrochemical process where a layer of copper is placed on a surface with the help of an electric current. At the beginning of the process, the sacrificial insert 26 which is going to be plated is cleaned, to prevent imperfections. Then an electric current is passed through a copper salt electrolyte solution causing copper to be plated on the sacrificial insert 26. The copper plated sacrificial insert 26′ is then removed from the copper plating bath. The copper plated sacrificial insert 26′ provides an interconnecting webs between the adjacent individual strands 28 while fully encapsulating the individual strands 28.

Alternative copper plating or coating processes can be used including, but not limited to, 1) plasma spraying, 2) high throughput coating methods like electroless deposition, 3) electron beam evaporation (EBE) and vacuum thermal evaporation, 4) Chemical or physical vapor deposition of their hybrid steps, including layer deposition (ALD), molecular beam epitaxy, and arc evaporation, 5) sputtering methods, including DC and RF sputtering, and DC Magnetron and reactive sputtering, and 6) laser deposition techniques such as pulsed laser deposition (PLD).

The sacrificial material can then be removed from within the copper plated ribbon shaped member 16 to create hollow passages 18 through the hollow copper ribbon shaped thermal conductor 16. The removal of the sacrificial material from within the copper plated ribbon shaped conductor 16 can include one of melting, burning, and dissolving the sacrificial material. Melting can occur at a temperature below a melting temperature of copper and above a melting temperature of the sacrificial material. A pressure can be applied to one end to force the molten sacrificial material out of the hollow thermal conductor 16. Liquids such as water, acids, or other solvents can be used to dissolve the sacrificial material from within the hollow thermal conductor 16. If hollow tubular inserts are used as a starting shape, the tubes can be retained inside the thermal conductor 16.

The ribbon-shaped copper thermal conductor 16 can be made from a thin layer of thermally conductive copper and can include one or more hollow coolant passages 18 therethrough. The ribbon-shaped copper thermal conductor 16 can be passed in serpentine manner through the battery pack 10 and between the battery cells. The ends of the ribbon-shaped copper thermal conductor(s) 16 can be connected to the coolant source 20 for providing coolant flow through the ribbon-shaped thermal conductor 16 in order to actively cool the battery cells 12. The ribbon-shaped copper thermal conductor 16 is capable of conforming to the tightly packed battery cells 12 and fills the space therebetween with improved thermal contact with the battery cells 12. The ribbon-shaped copper thermal conductors can also be wrapped around the battery cells and individually connected to appropriate plumbing connections.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A process for making a ribbon-shaped hollow thermal conductor, comprising:
forming a sacrificial material into an insert including a plurality of parallel strands;
plating the sacrificial insert with copper to form a ribbon-shaped structure;
removing the sacrificial material from within the ribbon-shaped structure to create a hollow passage through a ribbon-shaped hollow copper thermal conductor.

2. The process for making a ribbon-shaped hollow thermal conductor according to claim 1, wherein the sacrificial material includes a metal including one of tin, indium, zinc, aluminum, and magnesium.

3. The process for making a ribbon-shaped hollow thermal conductor according to claim 1, wherein the sacrificial material includes a conductive polymer including one of polyamides, epoxies, polyesters, polyethylenes, acrylics, polyphenylene sulfides, polycarbonate, and acrylonitrile butadiene styrene.

4. The process for making a ribbon-shaped hollow thermal conductor according to claim 1, wherein the sacrificial material includes a conductive hard wax including one of paraffin wax, montan wax, and polyethylene wax.

5. The process for making a ribbon-shaped hollow thermal conductor according to claim 4, wherein the conductive hard wax further includes a filler.

6. The process for making a ribbon-shaped hollow thermal conductor according to claim 1, wherein the sacrificial material includes a polymer including one of polyethylene glycol, polyacrylamides, polyacrylic acid copolymer, and polyvinyl alcohol.

7. The process for making a ribbon-shaped hollow thermal conductor according to claim 1, wherein the sacrificial insert is formed by one of casting and extruding a metal into a coil shape.

8. The process for making a ribbon-shaped hollow thermal conductor according to claim 1, wherein the sacrificial insert is formed by one of extruding and electropolymerizing a polymer in a template.

9. The process for making a ribbon-shaped hollow thermal conductor according to claim 1, wherein the sacrificial insert is formed by molding a polymer.

10. The process for making a ribbon-shaped hollow thermal conductor according to claim 1, wherein the sacrificial insert is formed by 3D printing.

11. The process for making a ribbon-shaped hollow thermal conductor according to claim 1, wherein removing the sacrificial material from the within the copper plated coil shaped member includes one of melting, burning, and dissolving the sacrificial material.

12. A battery pack, comprising:
a housing;
a plurality of battery cells in the housing;
a ribbon-shaped hollow copper conductor disposed between at least one adjacent group of the plurality of battery cells; and
a coolant source connected to the ribbon-shaped hollow copper conductor.

13. The battery pack according to claim 12, wherein the ribbon-shaped hollow copper conductor includes a plurality of spaced passages therethrough.

14. The battery pack according to claim 12, wherein the coolant source includes a liquid coolant that is pumped through the ribbon-shaped hollow copper conductor.

15. The battery pack according to claim 12, wherein the ribbon-shaped hollow copper conductor has a height of between 50-100 percent of a height of the battery cells.

16. The battery pack according to claim 15, wherein the ribbon-shaped hollow copper conductor has a thickness of between 1 and 3 mm.

17. The battery pack according to claim 12, wherein the ribbon-shaped hollow copper conductor has a thickness of between 1 and 3 mm.

18. A battery pack, comprising:
a housing;
a plurality of battery cells in the housing;
a plurality of ribbon-shaped hollow copper conductors wrapped around at least a portion of respective ones of the plurality of battery cells; and
a coolant source connected to the ribbon-shaped hollow copper conductors.

19. The battery pack according to claim 18, wherein the ribbon-shaped hollow copper conductor includes a plurality of spaced passages therethrough.

20. The battery pack according to claim 18, wherein the coolant source includes a liquid coolant that is pumped through the ribbon-shaped hollow copper conductor.
